(19) United States
(12) Patent Application Publication
(10) Pub. No.: US 2026/0188058 A1
(43) Pub. Date: Jul. 2, 2026

(54) SYSTEM AND METHOD OF OPERATING SYSTEM

(71) Applicant: TOYOTA JIDOSHA KABUSHIKI KAISHA, Toyota-shi (JP)

(72) Inventors: Masato ENDO, Nagoya-shi (JP); Shuhei MANABE, Toyota-shi (JP)

(73) Assignee: TOYOTA JIDOSHA KABUSHIKI KAISHA, Toyota-shi (JP)

(21) Appl. No.: 19/430,118

(22) Filed: Dec. 22, 2025

(30) Foreign Application Priority Data
Dec. 26, 2024 (JP) 2024-231169

(51) Int. Cl. G07C 5/00; G06V 10/94; G06V 20/59; G10L 25/51

(52) U.S. Cl. CPC G07C 5/008; G06V 10/95; G06V 20/597; G10L 25/51

(57) ABSTRACT

A system includes a terminal apparatus to be used by a driver of a vehicle, and a server apparatus communicating with the terminal apparatus. The terminal apparatus has a first diagnostic model to notify the driver of a diagnostic result according to the driver's driving at a first time. The server apparatus has a second diagnostic model to notify the driver of a diagnostic result according to the driver's driving at a second time longer than the first time. The terminal apparatus holds first information to be used for a diagnosis by the first diagnostic model, among information acquired at the time of the driver's driving, and transmits second information other than the first information to the server apparatus, to use the second information for a diagnosis by the second diagnostic model.

### CROSS-REFERENCE TO RELATED APPLICATION

This application claims priority to Japanese Patent Application No. 2024-231169, filed on Dec. 26, 2024, the entire contents of which are incorporated herein by reference.

### TECHNICAL FIELD

The present disclosure relates to a system and a method of operating the system.

### BACKGROUND

Technology for diagnosing the state of a mobile object including a vehicle, based on the behavior of the mobile object is known. For example, Patent Literatures (PTLs) 1 to 3 disclose systems that diagnose a vehicle or the like by processing, on a cloud server, information obtained by detecting the behavior of the vehicle or the like.

### CITATION LIST

### Patent Literature

PTL 1: JP 2017-013742 A
PTL 2: JP 2019-131187 A
PTL 3: JP 2021-196678 A

### SUMMARY

There is room for improvement in convenience for a driver when the driver is notified of various diagnostic results regarding driving of a vehicle using artificial intelligence (AI) and the like.

Hereinafter, a system that enables improved convenience for a driver when the driver is notified of diagnostic results regarding driving of a vehicle will be disclosed.

A system according to the present disclosure includes:
a terminal apparatus to be used by a driver of a vehicle; and
a server apparatus configured to communicate with the terminal apparatus,
wherein
the terminal apparatus has a first diagnostic model configured to notify the driver of a diagnostic result according to the driver's driving at a first time,
the server apparatus has a second diagnostic model configured to notify the driver of a diagnostic result according to the driver's driving at a second time longer than the first time, and
the terminal apparatus is configured to hold first information to be used for a diagnosis by the first diagnostic model, among information acquired at the time of the driver's driving, and transmit second information other than the first information to the server apparatus, to use the second information for a diagnosis by the second diagnostic model.

A method of operating a system according to another aspect of the preset disclosure is a method of operating a system including a terminal apparatus to be used by a driver of a vehicle and a server apparatus configured to communicate with the terminal apparatus, the terminal apparatus having a first diagnostic model configured to notify the driver of a diagnostic result according to the driver's driving at a first time, the server apparatus having a second diagnostic model configured to notify the driver of a diagnostic result according to the driver's driving at a second time longer than the first time, the method including holding, by the terminal apparatus, first information to be used for a diagnosis by the first diagnostic model, among information acquired at the time of the driver's driving, and transmitting second information other than the first information to the server apparatus, to use the second information for a diagnosis by the second diagnostic model.

The system and the like according to the present disclosure make it possible to improve the convenience of a driver when the driver is notified of diagnostic results regarding driving of a vehicle.

### BRIEF DESCRIPTION OF THE DRAWINGS

In the accompanying drawings:

FIG. 1 is a diagram illustrating an example of a configuration of an information processing system;

FIG. 2 is a sequence diagram illustrating an example of operations of the information processing system;

FIG. 3 is a flowchart illustrating an example of operations of an in-vehicle apparatus;

FIG. 4 is a sequence diagram illustrating an example of operations of an information processing system according to a variation; and

FIG. 5 is a flowchart illustrating an example of operations of an in-vehicle apparatus according to a variation.

### DETAILED DESCRIPTION

An embodiment will be described below.

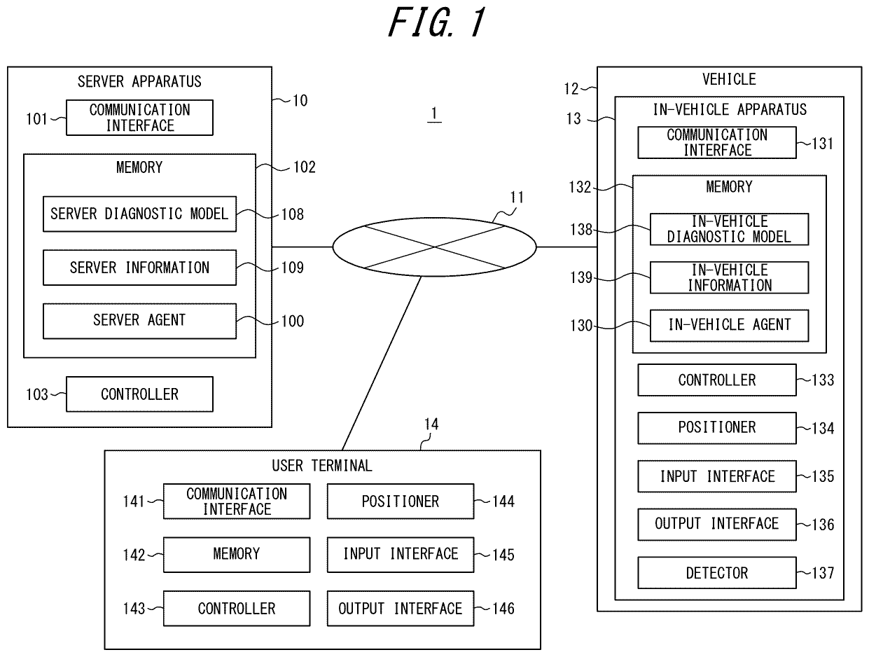

FIG. 1 is a diagram illustrating an example of a configuration of an information processing system according to the embodiment. An information processing system 1 includes at least one server apparatus 10, at least one in-vehicle apparatus 13, and at least one user terminal 14 that are communicably connected to each other via a network 11. The server apparatus 10 is, for example, a server computer that belongs to a cloud computing system or another computing system, and functions as a server that implements various functions. The in-vehicle apparatus 13 is, for example, a navigation system or the like that has a communication function and an information processing function, and is mounted in a vehicle 12. The vehicle 12 is a vehicle such as a passenger car or a commercial vehicle, and part or all of the driving is performed manually by a driver. The vehicle 12 is any type of automobile such as a gasoline vehicle, a Battery Electric Vehicle (BEV), a Hybrid Electric Vehicle (HEV), a Plug-in Hybrid Electric Vehicle (PHEV), or a Fuel Cell Electric Vehicle (FCEV). The user terminal 14 is an information processing terminal used by the driver of the vehicle 12 and is, for example, a smartphone, a tablet terminal, a personal computer (PC), or the like. The network 11 is the Internet, for example, but may also be an ad-hoc network, a LAN, a Metropolitan Area Network (MAN), other networks, or a combination of two or more thereof.

In the present embodiment, the information processing system 1 assists in diagnosing the vehicle 12 and notifying the driver of the diagnostic results. The information processing system 1 includes the in-vehicle apparatus 13 or the user terminal 14 as a “terminal apparatus” to be used by the driver of the vehicle 12, and the server apparatus 10 that communicates with the in-vehicle apparatus 13 and the user terminal 14. The in-vehicle apparatus 13 has a first diagnostic model (hereinafter referred to as an in-vehicle diagnostic model) 138 for notifying the driver of a diagnostic result according to the driver's driving at a first time. The server apparatus 10 has a second diagnostic model (hereinafter referred to as a server diagnostic model) 108 for notifying the driver of a diagnostic result according to the driver's driving at a second time longer than the first time. The in-vehicle apparatus 13 holds information (hereinafter referred to as in-vehicle information) 139 to be used for a diagnosis by the in-vehicle diagnostic model 138, among information (hereinafter referred to as target information) acquired at the time of the driver's driving, and transmits information other than the in-vehicle information 139 to the server apparatus 10 for use in a diagnosis by the server diagnostic model 108. Thus, the in-vehicle information 139 is stored in the in-vehicle apparatus 13, while the information other than the in-vehicle information 139, which is transmitted from the in-vehicle apparatus 13 to the server apparatus 10, is stored as server information 109 in the server apparatus 10. The in-vehicle apparatus 13 performs a diagnosis using the in-vehicle information 139 by the in-vehicle diagnostic model 138 and notifies the driver of the diagnostic result. In addition, the in-vehicle apparatus 13 can train or enhance the in-vehicle diagnostic model 138 using the in-vehicle information 139. On the other hand, the server apparatus 10 performs a diagnosis using the server information 109 by the server diagnostic model 108 and notifies the driver of the diagnostic result via the user terminal 14. In addition, the server apparatus 10 can train or enhance the server diagnostic model 108 using the server information 109.

When attempting to derive a diagnostic result according to the driver's driving by the server diagnostic model 108 and notify the driver from the server apparatus 10, there is a possibility that the time until the driver receives the notification of the diagnostic result becomes long due to communication delays or the like in the processes of transmitting information acquired according to the driving from the in-vehicle apparatus 13 to the server apparatus 10 and transmitting the diagnostic result from the server apparatus 10 to the in-vehicle apparatus 13. In this regard, according to the present embodiment, it is possible to obtain a diagnostic result that requires notification at a fast timing, such as nearly real-time, by the in-vehicle diagnostic model 138 in the in-vehicle apparatus 13, and notify the driver. On the other hand, it is possible to obtain a diagnostic result that has no problem even when it takes some time until notification, by the server diagnostic model 108 in the server apparatus 10, and notify the driver. Thus, the in-vehicle apparatus 13 can obtain the notification required by the driver in a shorter time, compared to when communicating with the server apparatus 10. That is, it becomes possible to improve the convenience of the driver when notifying the driver of the diagnostic results regarding the driving of the vehicle 12.

Next, an example of a configuration of the server apparatus 10 will be described.

The server apparatus 10 includes a communication interface 101, a memory 102, and a controller 103. The server apparatus 10 may be a single computer or may be two or more computers that are communicably connected to each other and operate in cooperation. When the server apparatus 10 is configured with two or more computers, the configuration illustrated in FIG. 1 is arranged as appropriate on the two or more computers.

The communication interface 101 includes one or more interfaces for communication. The interfaces for communication include, for example, a LAN interface. The communication interface 101 receives information to be used for operations of the controller 103, and transmits information obtained by operations of the controller 103. The server apparatus 10 is connected to the network 11 by the communication interface 101, and communicates information with the in-vehicle apparatus 13 and the user terminal 14 via the network 11.

The memory 102 includes, for example, one or more semiconductor memories, one or more magnetic memories, one or more optical memories, or a combination of at least two of these types, to function as a main memory, an auxiliary memory, or a cache memory. The semiconductor memories are, for example, random access memory (RAM) or read only memory (ROM). The RAM is, for example, static RAM (SRAM) or dynamic RAM (DRAM). The ROM is, for example, electrically erasable programmable ROM (EEPROM). The memory 102 stores the information to be used for the operations of the controller 103 and the information obtained by the operations of the controller 103.

The controller 103 includes one or more processors, one or more dedicated circuits, or a combination thereof. The processors are general purpose processors, such as central processing units (CPUs), or dedicated processors, such as graphics processing units (GPUs), dedicated to specific processing. The dedicated circuits are, for example, field-programmable gate arrays (FPGAs), application specific integrated circuits (ASICs), or the like. The controller 103 executes information processing related to the operations of the server apparatus 10 while controlling components of the server apparatus 10.

The functions of the server apparatus 10 are realized by execution of a control program by a processor included in the controller 103. The control program is a program for causing a computer to execute processing of steps included in the operations of the server apparatus 10, thereby enabling the computer to realize functions corresponding to the processing of the steps. That is, the control program is a program for causing a computer to function as the server apparatus 10. Some or all of the functions of the server apparatus 10 may be realized by a dedicated circuit included in the controller 103. The control program may be stored on a non-transitory recording/storage medium readable by the server apparatus 10, and be read from the medium by the server apparatus 10.

In the present embodiment, the memory 102 stores the server diagnostic model 108, the server information 109, and a server agent 100. The server diagnostic model 108 is an AI model that has learned diagnostic results corresponding to past server information 109, to diagnose the driver's driving tendency corresponding to the server information 109. The server information 109 is information for diagnosing the driver's driving tendency, and includes information and the like indicating, for example, the number of dangerous driving events and the degree of vehicle wear. The dangerous driving events are diagnosed in the in-vehicle apparatus 13, as described later. Information indicating the degree of wear of the vehicle 12 is also obtained in the in-vehicle apparatus 13. The information indicating the degree of wear of the vehicle 12 includes information such as oil level, the degree of brake pad wear, and the degree of in-vehicle battery degradation. The server apparatus 10 acquires the server information 109 including a diagnostic history, from the in-vehicle apparatus 13. The server agent 100 is a dialogue AI module that generates a notification of a diagnostic result from the server diagnostic model 108 to the driver, and has a natural language processing function, a knowledge base regarding diagnostic results and the driver's preferences, and the like. The server diagnostic model 108 executed by the controller 103 diagnoses a tendency toward dangerous driving when the number of dangerous driving events is equal to or greater than a certain level. The server diagnostic model 108 diagnoses a tendency toward vehicle wear when the degree of vehicle wear is equal to or greater than a certain level. The criteria for diagnosing the number of dangerous driving events and the degree of vehicle wear may be set as appropriate, or generated by the server diagnostic model 108 in the course of learning. Then, the server agent 100 executed by the controller 103 generates a notification to the driver according to the diagnostic result.

Next, an example of a configuration of the in-vehicle apparatus 13 will be described.

The in-vehicle apparatus 13 includes a communication interface 131, a memory 132, a controller 133, a positioner 134, an input interface 135, an output interface 136, and a detector 137. These components may be configured as a single control apparatus, as two or more control apparatuses, or with another apparatus such as a control apparatus and a communication device. The control apparatus includes, for example, an electronic control unit (ECU) or the like. The communication device includes, for example, a data communication module (DCM) or the like. The components are communicably connected to each other or to equipment in the vehicle 12, through an in-vehicle network compliant with a standard such as a controller area network (CAN). The in-vehicle apparatus 13 may be configured to include, in part, a device equivalent to the user terminal 14.

The communication interface 131 includes a communication module compliant with a wired or wireless LAN standard, a module compliant with a mobile communication standard such as long term evolution (LTE), 4th generation (4G), or 5th generation (5G), or the like. The in-vehicle apparatus 13 connects to the network 11 via a nearby router apparatus or a mobile communication base station using the communication interface 131, and communicates information with other apparatuses over the network 11.

The memory 132 includes one or more semiconductor memories, one or more magnetic memories, one or more optical memories, or a combination of at least two of these types. The semiconductor memories are, for example, RAM or ROM. The RAM is, for example, SRAM or DRAM. The ROM is, for example, EEPROM. The memory 132 functions as, for example, a main memory, an auxiliary memory, or a cache memory. The memory 132 stores information to be used for operations of the controller 133 and information obtained by operations of the controller 133.

The controller 133 includes one or more processors, one or more dedicated circuits, or a combination thereof. The processors are general purpose processors such as CPUs, dedicated processors such as GPUs that are specialized for specific processing. The dedicated circuits are, for example, FPGAs or ASICs. The controller 133 executes information processing related to operations of the in-vehicle apparatus 13 while controlling components of the in-vehicle apparatus 13.

The functions of the controller 133 are realized by execution of a control/processing program by a processor included in the controller 133. The control/processing program is a program for causing a computer to execute processing of steps included in operations of the controller 133, thereby enabling the computer to realize the functions corresponding to the processing of the steps. That is, the control/processing program is a program for causing a computer to function as the controller 133. Some or all of the functions of the controller 133 may be realized by a dedicated circuit included in the controller 133.

The positioner 134 includes one or more global navigation satellite system (GNSS) receivers. The GNSS includes, for example, Global Positioning System (GPS), Quasi-Zenith Satellite System (QZSS), BeiDou, Global Navigation Satellite System (GLONASS), and/or Galileo. The positioner 134 transmits a positioning result to the controller 133, and the controller 133 calculates positional information on the in-vehicle apparatus 13, that is, the vehicle 12.

The input interface 135 includes one or more interfaces for input. The interfaces for input include, for example, a microphone that accepts voice input, physical keys, capacitive keys, a pointing device, a touch screen integrally provided with a display, or the like. The interfaces for input include an interface with a camera that is provided in the vehicle 12 to capture images of the interior or exterior of the vehicle 12. The camera may be built into the in-vehicle apparatus 13 or may be separate. The input interface 135 accepts input operations of information to be used for operations of the controller 133 by a user such as the driver, voice, or captured images of the driver or the like by a camera, and transmits the accepted information to the controller 133.

The output interface 136 includes one or more interfaces for output. The interfaces for output include, for example, a speaker that outputs sound, a display that outputs images, and the like. The display is, for example, a liquid crystal display (LCD) or an organic electro-luminescent (EL) display. The output interface 136 outputs information to be obtained by operations of the controller 133.

The detector 137 has sensors that detect various events occurring in the vehicle 12, or interfaces with such sensors. The sensors include, for example, sensors that detect the speed, acceleration in a longitudinal direction, acceleration in a lateral direction, deceleration, accelerator operation amount, brake operation amount, steering angle, turn signal lighting time, fuel consumption per unit time, eco mode selection state, odometer value, safety equipment operation information, remaining amounts of engine oil and the like, degree of wear of brake pads, degree of battery degradation, and the like of the vehicle 12. The sensors include radar using millimeter waves, infrared rays, or the like that detects objects around the vehicle 12. The detector 137 transmits vehicle information indicating various states of the vehicle 12 detected by the sensors to the controller 133.

The controller 133 controls each of the communication interface 131, the memory 132, the positioner 134, the input interface 135, the output interface 136, and the detector 137 while exchanging various information with these components, and also controls operations of the vehicle 12. When the vehicle 12 travels, the controller 133 presents various information such as route information necessary for driving to the driver via the output interface 136 to provide a navigation function, and controls partial automated driving of the vehicle 12.

In the present embodiment, the memory 132 stores the in-vehicle diagnostic model 138, the in-vehicle information 139, and an in-vehicle agent 130. The in-vehicle diagnostic model 138 is an AI model that has learned diagnostic results corresponding to past in-vehicle information 139, to diagnose the driver's operation feature or the driver's condition corresponding to the in-vehicle information 139. The in-vehicle information 139 is information indicating the driver's operation feature or the driver's condition at the time of driving. The operation feature includes information indicating control amounts in driving operations or the motion state of the vehicle 12. The control amounts in driving operations include the control amounts of the brake, accelerator, steering, turn signals, and the like. The control amounts include the amount of change in each control amount per unit time. The information indicating the motion state of the vehicle 12 is the moving speed of the vehicle 12, the acceleration in travel and lateral directions of the vehicle 12, the distance to other vehicles detected by radar or captured images of the exterior of the vehicle 12, or the like. The information indicating the driver's condition at the time of driving is a captured image, voice, or the like of the driver. The in-vehicle agent 130 is a dialogue AI module that generates a notification of a diagnostic result from the in-vehicle diagnostic model 138 to the driver, and has a natural language processing function, a knowledge base regarding diagnostic results and the driver's preferences, and the like. The in-vehicle diagnostic model 138 executed by the controller 133 diagnoses dangerous driving when, for example, the control amounts in driving operations or the motion state of the vehicle 12 indicate values corresponding to dangerous driving. The in-vehicle diagnostic model 138 diagnoses fatigue accumulation when, for example, the captured image, voice, or the like indicating the driver's condition at the time of driving represents the driver's drowsiness, fatigue, or the like. The criteria for diagnosing dangerous driving and fatigue accumulation may be set appropriately or generated by the in-vehicle diagnostic model 138 in the course of learning. Then, the in-vehicle agent 130 generates a notification to the driver according to the diagnostic result.

Next, an example of a configuration of the user terminal 14 will be described.

The user terminal 14 includes a communication interface 141, a memory 142, a controller 143, a positioner 144, an input interface 145, and an output interface 146.

The communication interface 141 includes a communication module compliant with a wired or wireless LAN standard, a module compliant with a mobile communication standard such as LTE, 4G, or 5G, or the like. The user terminal 14 connects to the network 11 via a nearby router apparatus or mobile communication base station using the communication interface 141, and communicates information with other apparatuses over the network 11.

The memory 142 includes one or more semiconductor memories, one or more magnetic memories, one or more optical memories, or a combination of at least two of these types. The semiconductor memories are, for example, RAM or ROM. The RAM is, for example, SRAM or DRAM. The ROM is, for example, EEPROM. The memory 142 functions as, for example, a main memory, an auxiliary memory, or a cache memory. The memory 142 stores information to be used for operations of the controller 143 and information obtained by operations of the controller 143.

The controller 143 includes one or more processors, one or more dedicated circuits, or a combination thereof. The processors are general purpose processors such as CPUs, or dedicated processors such as GPUs that are specialized for specific processing. The dedicated circuits are, for example, FPGAs or ASICs. The controller 143 executes information processing related to operations of the user terminal 14 while controlling components of the user terminal 14.

The positioner 144 includes one or more GNSS receivers. GNSS includes, for example, GPS, QZSS, BeiDou, GLONASS, and/or Galileo. The positioner 144 transmits a positioning result to the controller 143, and the controller 143 calculates positional information on the user terminal 14.

The input interface 145 includes one or more interfaces for input. The interfaces for input include, for example, a microphone that accepts voice input, physical keys, capacitive keys, a pointing device, a touch screen integrally provided with a display, a camera that captures images, or the like. The input interface 145 accepts operations for inputting information to be used for operations of the controller 143 and transmits the input information to the controller 143.

The output interface 146 includes one or more interfaces for output. The interfaces for output include, for example, a speaker, a display, or the like. The display is, for example, an LCD or an organic EL display. The output interface 146 outputs information obtained by operations of the controller 143.

The functions of the controller 143 are realized by execution of a control/processing program by a processor included in the controller 143. The control/processing program is a program for causing a computer to execute processing of steps included in operations of the controller 143, thereby enabling the computer to realize the functions corresponding to the processing of the steps. That is, the control/processing program is a program for causing a computer to function as the controller 143. Some or all of the functions of the controller 143 may be realized by a dedicated circuit included in the controller 143.

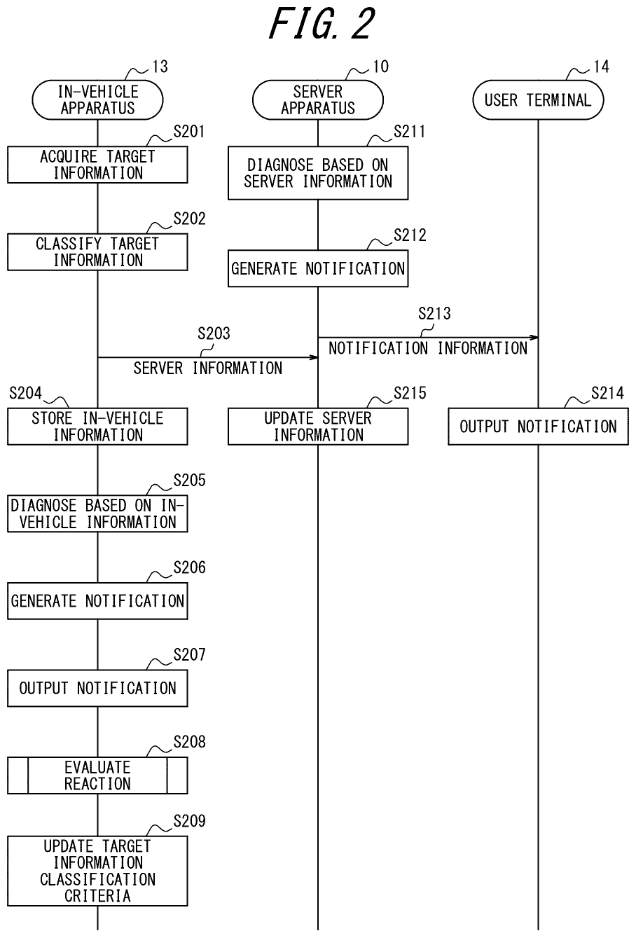

Next, operations of the information processing system 1 will be described with reference to FIG. 2 to FIG. 5.

FIG. 2 is a sequence diagram illustrating an operation procedure of the information processing system 1 according to the present embodiment. FIG. 2 illustrates a procedure in coordinated operations of the server apparatus 10, the in-vehicle apparatus 13, and the user terminal 14. The steps pertaining to the various information processing by the server apparatus 10, the in-vehicle apparatus 13, and the user terminal 14 in FIG. 2 are performed by the respective controllers 103, 133, and 143. The steps pertaining to transmitting and receiving various information to and from the server apparatus 10, the in-vehicle apparatus 13, and the user terminal 14 are performed by the respective controllers 103, 133, and 143 transmitting and receiving information to and from each other via the respective communication interfaces 101, 131, and 141. In the server apparatus 10, the in-vehicle apparatus 13, and the user terminal 14, the respective controllers 103, 133, and 143 appropriately store information to be transmitted, received, or processed, in the respective memories 102, 132, and 142. Furthermore, in the in-vehicle apparatus 13 and the user terminal 14, the controllers 133 and 143 accept input of various information by the respective input interfaces 135 and 145, and output various information by the respective output interfaces 136 and 146.

The steps S201 to S209 of the in-vehicle apparatus 13 in FIG. 2 are executed at any cycles of several tens of milliseconds to several seconds when the vehicle 12 is in motion, for example.

In S201, the in-vehicle apparatus 13 acquires target information. The controller 133 acquires target information including the control amounts of the brake, accelerator, steering, turn signals, and the like, the moving speed, acceleration in travel and lateral directions, and distance to other vehicles of the vehicle 12, and an image, voice, and the like of the driver, through various sensors and input interfaces provided in the vehicle 12. Each piece of information may be timestamped at the time of acquisition.

In S202, the in-vehicle apparatus 13 classifies the target information. The controller 133 classifies the target information into in-vehicle information 139 and the other server information 109. The controller 133 classifies the target information by attaching a label indicating in-vehicle information or server information to each type of target information. The memory 132 stores reference information in which each type of target information is pre-classified into the in-vehicle information 139 and the server information 109, and the controller 133 labels the acquired target information according to the type with reference to the reference information.

In S203, the in-vehicle apparatus 13 transmits the server information 109 to the server apparatus 10. After transmitting the server information 109 to the server apparatus 10, the in-vehicle apparatus 13 may delete the server information 109 from the memory 102 to free up storage capacity.

In S204, the in-vehicle apparatus 13 stores the in-vehicle information 139.

In S205, the in-vehicle apparatus 13 performs a diagnosis using the in-vehicle information 139. In the in-vehicle apparatus 13, the controller 133 executes the in-vehicle diagnostic model 138 to perform a diagnosis using the classified in-vehicle information 139.

In S206, the in-vehicle apparatus 13 generates a notification based on the diagnostic result. The controller 133 generates, as a notification, a message such as “Danger: Hard Braking!”, “Danger: Sudden Start!”, or “Danger: Sharp Steering!” to warn of danger using the in-vehicle agent 130 when the driver's operation feature is diagnosed to include hard braking, rapid acceleration, sharp steering, or the like based on the control amount of braking, acceleration, and the like, and a message such as “Wake Up!” or “Look Ahead!” to encourage alertness and attention when the driver's condition is diagnosed to include drowsiness, fatigue, decreased attention, or the like. Alternatively, the notification may be flashing of warning light or output of warning sound, in addition to or instead of the message.

In S207, the in-vehicle apparatus 13 outputs the notification to the driver. The message of the notification may be displayed on a display of the output interface 136 or output as sound through a speaker. Additionally, the warning light may flash or the warning sound may be output. Such notification output can contribute to deterring dangerous driving, drowsiness, or the like by the driver.

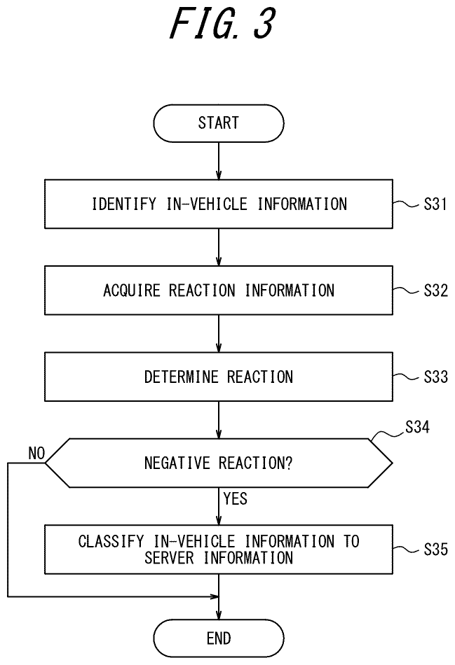

In S208, the in-vehicle apparatus 13 evaluates the reaction of the driver who has received the notification. A detailed example of the process of step S208 is illustrated in FIG. 3.

FIG. 3 is a flowchart illustrating an example of the procedure for evaluating the driver's reaction in the in-vehicle apparatus 13. Each step in FIG. 3 is a step of information processing executed by the controller 133.

In S31, the controller 133 identifies the in-vehicle information 139. The controller 133 reads the in-vehicle information 139, based on which the diagnosis is performed, from the memory 102 and identifies the in-vehicle information 139.

In S32, the controller 133 acquires reaction information. The reaction information is information indicating the driver's reaction to the notification, and includes the driver's captured image, voice information, and the like. The controller 133 acquires the captured image and the voice information from the input interface.

In S33, the controller 133 determines whether the reaction is positive or negative. The controller 133 determines whether the reaction is positive or negative based on, for example, the driver's expression in the captured image. The controller 133 performs any image processing on the captured image. The controller 133 extracts the driver's face image, detects landmarks in the face image, and determines whether the driver's expression belongs to expression patterns indicating discomfort based on the shape or the like of the arrangement of the landmarks. Alternatively, the controller 133 analyzes the driver's speech based on the voice information and determines whether a phrase indicating discomfort is included. Information on the expression patterns indicating discomfort, phrases, and the like is pre-set as appropriate. When the driver's expression or speech indicates discomfort, the controller 133 determines that the reaction is negative. Otherwise, the controller 133 determines that the reaction is positive. Upon determining that the reaction is negative (Yes in step S34), the controller 133 proceeds to step S35. Upon determining that the reaction is positive, that is, upon not determining that the reaction is negative (No in step S34), the controller 133 bypasses step S35 and ends the procedure in FIG. 3.

In S35, the controller 133 classifies the in-vehicle information 139 identified in step S31 as the server information 109.

Returning to FIG. 2, in step S209, the in-vehicle apparatus 13 updates criteria for classifying the target information. For example, the controller 133 of the in-vehicle apparatus 13 updates, based on the result classified in step S35 of FIG. 3, the reference information that serves as the criteria for classifying the target information into the in-vehicle information 139 or the server information 109. The controller 133 updates the criteria by changing the label for each type of target information, for example. Thereby, target information classified from the in-vehicle information 139 to the server information 109 is processed as the server information 109 in the subsequent processes.

Steps S211 to S213 of the server apparatus 10 in FIG. 2 are executed, for example, at any cycle of several days to several weeks.

In S211, the server apparatus 10 performs a diagnosis using the server information 109. In the server apparatus 10, the controller 103 executes the server diagnostic model 108 to perform a diagnosis using the server information 109.

In S212, the server apparatus 10 generates a notification based on the diagnostic result. The controller 103 generates, as a notification, a warning message such as “Let's keep speed down”, “Let's brake early”, “Let's turn slowly at curves”, “Let's signal early”, or “Let's maintain a safe distance” using the server agent 100 when the controller 103 diagnoses a tendency toward dangerous driving. Alternatively, upon diagnosing a tendency toward vehicle wear, the controller 103 generates, as a notification, a message such as “It's time for vehicle maintenance” or “Let's check brakes.”

In S213, the in-vehicle apparatus 13 transmits notification information to the user terminal 14. The notification information is information for outputting the notification.

In S214, the user terminal 14 outputs the notification to the driver. The message of the notification may be displayed on a display of the output interface 146 or output as sound through a speaker. Such output of the notification can contribute to raising awareness of the tendency toward dangerous driving by the driver and prompting maintenance checks of the vehicle 12. Although the amount of information that can be provided to the driver during driving is limited in the in-vehicle apparatus 13, the driver can review own driving tendency later.

The server apparatus 10 updates the server information 109 in step S215 whenever the server information 109 is transmitted from the in-vehicle apparatus 13 in step S203. For example, the controller 103 updates information indicating the degree of wear of the vehicle 12, such as oil level, the degree of brake pad wear, and the degree of in-vehicle battery degradation, to the latest information, and stores the latest information in the memory 102. Thus, the information indicating the degree of wear of the vehicle 12 is updated as needed and used for a later diagnosis by the server diagnostic model 108.

According to the operation procedure as described above, the in-vehicle information 139 and the updated reference information are held in the in-vehicle apparatus 13. Therefore, the in-vehicle apparatus 13 can train the in-vehicle diagnostic model 138 using the accumulated in-vehicle information 139 and reference information as training data at any timing. This makes it possible to adjust the in-vehicle diagnostic model 138 to output diagnostic results more suitable for the driver.

According to the operation procedure as described above, the in-vehicle information 139 and the updated reference information are accumulated in the in-vehicle apparatus 13. Therefore, the in-vehicle apparatus 13 can train the in-vehicle diagnostic model 138 using the accumulated in-vehicle information 139 and reference information as training data at any timing. This makes it possible to adjust the in-vehicle diagnostic model 138 to output diagnostic results more suitable for the driver.

Since server information 109 transmitted from multiple vehicles 12 is accumulated in the server apparatus 10, the in-vehicle diagnostic model 108 may be trained using such server information 109 at any timing as training data.

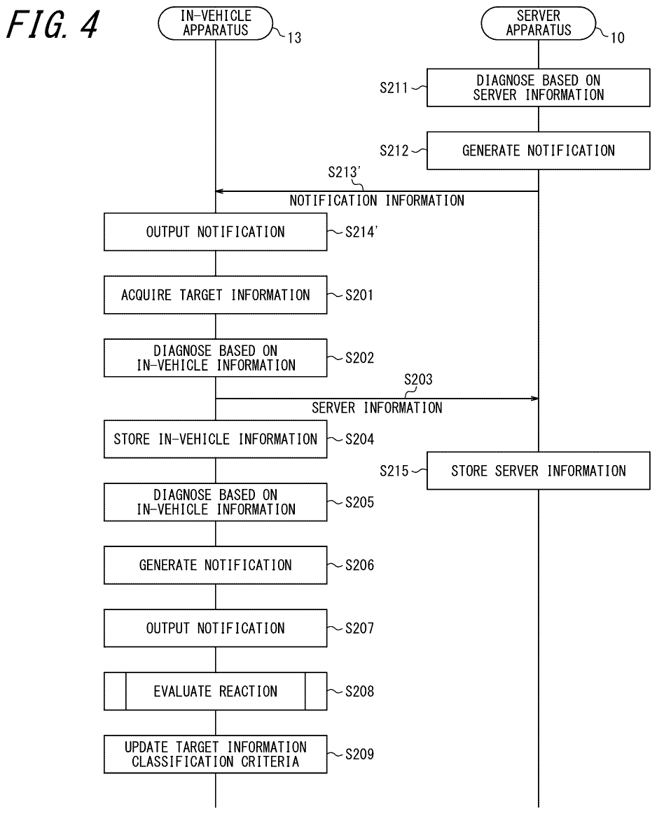

FIG. 4 is a sequence diagram illustrating an example of an operation procedure of the information processing system 1 according to a variation. The example of the operation procedure in FIG. 4 is an example of an operation procedure executed by the in-vehicle apparatus 13, instead of the user terminal 14, and differs from FIG. 2 in that steps S213′ and S214′ are executed by the in-vehicle apparatus 13 instead of steps S213 and S214 in FIG. 2. That is, the server apparatus 10 transmits notification information based on a diagnostic result to the in-vehicle apparatus 13 in step S213′. Then, the in-vehicle apparatus 13 outputs a notification in step S214′ in the same manner as the user terminal 14 does in step S214 of FIG. 2.

By executing the procedure as illustrated in FIG. 2 or FIG. 4, the in-vehicle apparatus 13 notifies the diagnostic result in near real-time according to the driver's driving operations or the driver's condition at the time of driving. On the other hand, the server apparatus 10 generates a diagnostic result according to the driver's driving tendency, which is acquired over a period of several days to several weeks, for example. Then, a notification is output to the driver by the in-vehicle apparatus 13 or the user terminal 14. When the user terminal 14 outputs the notification as in the example of FIG. 2, the driver can obtain the notification about own driving tendency even when away from the vehicle 12.

Furthermore, by evaluating the driver's reaction to the notification through the procedure illustrated in FIG. 3, when the driver finds the notification output from the in-vehicle diagnostic model 138 in near real-time to be bothersome, target information based on which such notification is generated is classified as server information 109 and transmitted to the server apparatus 10 to prevent the in-vehicle diagnostic model 138 from using such information from then on, thereby reducing bothersome notifications.

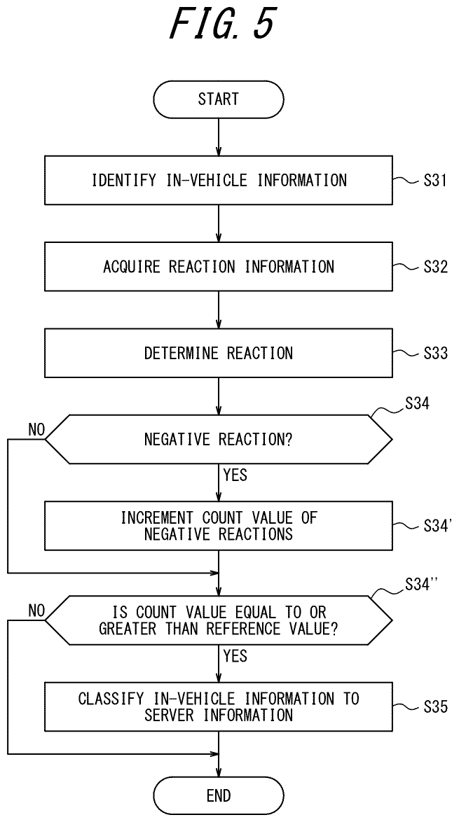

FIG. 5 is a flowchart illustrating an example of the procedure for evaluating the driver's reaction to the notification in another variation. The example of the procedure in FIG. 5 differs from the example of the procedure in FIG. 3 in that steps S34′ and S34′′ are inserted after step S34.

The controller 133 of the in-vehicle apparatus 13 increments the count value of negative reactions, which is associated with each type of target information, in step S34′ and proceeds to step S34′′ when the driver's reaction is negative (Yes) in step S34, and bypasses step S34′ and proceeds to step S34′′ when the driver's reaction is not negative (No) in step S34.

When the count value is equal to or greater than any reference value, for example, any value from 3 to 10 (Yes) in step S34″, the controller 133 classifies the in-vehicle information 139 identified in step S31 as server information 109. When the count value is less than the reference value (No) in step S34″, the controller 133 bypasses step S35 and ends the process.

Such a variation can reduce the risk of unnecessarily classifying the in-vehicle information 139 as server information 109 when the driver accidentally gives a negative reaction.

In another variation, instead of evaluating the driver's reaction, the in-vehicle apparatus 13 may classify the in-vehicle information 139 as server information 109 in response to explicit input from the driver, such as a touch operation on a button to stop the notification of the diagnostic result on a touch panel. Such operational input may be conditioned to occur within any time after the notification of the diagnostic result, for example, within a few seconds to ten seconds. This makes it possible to more reliably classify target information in accordance with the driver's intentions.

According to the present embodiment described above, the driver can obtain the diagnostic result regarding own driving operations or own condition in near real-time according to the preferences, and can also obtain the diagnostic result regarding own driving tendency after a certain period, to review own driving tendency. Therefore, it becomes possible to improve the convenience of the driver when the driver is notified of the diagnostic results regarding the driving of the vehicle 12. By transmitting the server information 109, which does not require near real-time diagnosis to the server apparatus 10, the in-vehicle apparatus 13 can save resources.

In the above embodiment, the order of steps S211 to S213 performed by the server apparatus 10 in FIG. 2 and each step in the in-vehicle apparatus 13 is not limited to the example in FIG. 2. The order of steps S211 to S213′ performed by the server apparatus 10 in FIG. 4 and steps S201 to S209 in the in-vehicle apparatus 13 is not limited to the example in FIG. 4.

In the above embodiment, processing/control programs that specify operations of the vehicle 12 and the user terminal 14 may be stored in the memory 102 of the server apparatus 10 or in the memory of another server apparatus, and downloaded to each apparatus via the network 11, or may be stored in a non-transitory recording/storage medium readable by each apparatus, and read from the medium by each apparatus.

While the embodiment has been described with reference to the drawings and examples, it should be noted that various modifications and revisions may be implemented by those skilled in the art based on the present disclosure. Accordingly, such modifications and revisions are included within the scope of the present disclosure. For example, functions or the like included in each means, each step, or the like can be rearranged without logical inconsistency, and a plurality of means, steps, or the like can be combined into one or divided.

Examples of some embodiments of the present disclosure are described below. However, it should be noted that the embodiments of the present disclosure are not limited to these examples.
[Appendix 1] A system comprising:
   a terminal apparatus to be used by a driver of a vehicle; and
   a server apparatus configured to communicate with the terminal apparatus,
   wherein
   the terminal apparatus comprises a first diagnostic model configured to notify the driver of a diagnostic result according to the driver's driving at a first time,
   the server apparatus comprises a second diagnostic model configured to notify the driver of a diagnostic result according to the driver's driving at a second time longer than the first time, and
   the terminal apparatus is configured to hold first information to be used for a diagnosis by the first diagnostic model, among information acquired at time of the driver's driving, and transmit second information other than the first information to the server apparatus, to use the second information for a diagnosis by the second diagnostic model.
[Appendix 2] The system according to appendix 1, wherein the terminal apparatus is configured not to transmit the first information to the server apparatus.
[Appendix 3] The system according to appendix 1 or 2, wherein the terminal apparatus is configured to train the first diagnostic model using the first information.
[Appendix 4] The system according to any one of appendices 1 to 3, wherein the server apparatus is configured to train the second diagnostic model using the second information.
[Appendix 5] The system according to any one of appendices 1 to 4, wherein
   the first information is information regarding the driver's driving operation or the driver's condition at time of driving, and
   the second information is information regarding the driver's driving tendency.

[Appendix 6] The system according to any one of appendices 1 to 5, wherein the terminal apparatus is configured to determine the first and second information, among the information acquired at the time of the driver's driving, in response to a predetermined operation by the driver.
[Appendix 7] The system according to any one of appendices 1 to 6, wherein the terminal apparatus is configured to determine the first and second information, among the information acquired at the time of the driver's driving, in response to the driver's reaction to the diagnostic result by the first diagnostic model.
[Appendix 8] The system according to appendix 7, wherein the terminal apparatus is configured to acquire the reaction from a captured image or voice of the driver.
[Appendix 9] A method of operating a system comprising a terminal apparatus to be used by a driver of a vehicle and a server apparatus configured to communicate with the terminal apparatus, the terminal apparatus comprising a first diagnostic model configured to notify the driver of a diagnostic result according to the driver's driving at a first time, the server apparatus comprising a second diagnostic model configured to notify the driver of a diagnostic result according to the driver's driving at a second time longer than the first time, the method comprising holding, by the terminal apparatus, first information to be used for a diagnosis by the first diagnostic model, among information acquired at time of the driver's driving, and transmitting second information other than the first information to the server apparatus, to use the second information for a diagnosis by the second diagnostic model.
[Appendix 10] The method according to appendix 9, wherein the terminal apparatus is configured not to transmit the first information to the server apparatus.
[Appendix 11] The method according to appendix 9 or 10, wherein the terminal apparatus is configured to train the first diagnostic model using the first information.
[Appendix 12] The method according to any one of appendices 9 to 11, wherein the server apparatus is configured to train the second diagnostic model using the second information.
[Appendix 13] The method according to any one of appendices 9 to 12, wherein
   the first information is information regarding the driver's driving operation or the driver's condition at time of driving, and
   the second information is information regarding the driver's driving tendency.
[Appendix 14] The method according to any one of appendices 9 to 13, wherein the terminal apparatus is configured to determine the first and second information, among the information acquired at the time of the driver's driving, in response to a predetermined operation by the driver.
[Appendix 15] The method according to any one of appendices 9 to 14, wherein the terminal apparatus is configured to determine the first and second information, among the information acquired at the time of the driver's driving, in response to the driver's reaction to the diagnostic result by the first diagnostic model.
[Appendix 16] The method according to appendix 15, wherein the terminal apparatus is configured to acquire the reaction from a captured image or voice of the driver.

1. A system comprising:
a terminal apparatus to be used by a driver of a vehicle; and
a server apparatus configured to communicate with the terminal apparatus,
wherein
the terminal apparatus is configured to acquire, by a detector, information indicating the driver's driving operation feature or the driver's condition at time of driving, and have a first diagnostic model configured to notify the driver of a diagnostic result according to the acquired information at a first time,
the server apparatus is configured to acquire information indicating the driver's driving tendency from the terminal apparatus, and have a second diagnostic model configured to notify the driver of a diagnostic result according to the acquired information at a second time longer than the first time, and
the terminal apparatus is configured to hold the information indicating the driver's driving operation feature or the driver's condition at the time of driving to be used for a diagnosis by the first diagnostic model, among information acquired at the time of the driver's driving, and transmit other information indicating the driver's driving tendency to the server apparatus, in order to use the other information for a diagnosis by the second diagnostic model, acquire a diagnostic result output from the second diagnostic model in the server apparatus, and output the diagnostic result.

2. A system comprising:
a terminal apparatus to be used by a driver of a vehicle; and
a server apparatus configured to communicate with the terminal apparatus,
wherein
the terminal apparatus comprises a first diagnostic model configured to notify the driver of a diagnostic result according to the driver's driving at a first time,
the server apparatus comprises a second diagnostic model configured to notify the driver of a diagnostic result according to the driver's driving at a second time longer than the first time, and
the terminal apparatus is configured to hold first information to be used for a diagnosis by the first diagnostic model, among information acquired at time of the driver's driving, and transmit second information other than the first information to the server apparatus, to use the second information for a diagnosis by the second diagnostic model.

3. The system according to claim 2, wherein the terminal apparatus is configured not to transmit the first information to the server apparatus.

4. The system according to claim 2, wherein the terminal apparatus is configured to train the first diagnostic model using the first information.

5. The system according to claim 2, wherein the server apparatus is configured to train the second diagnostic model using the second information.

6. The system according to claim 2, wherein
the first information is information regarding the driver's driving operation or the driver's condition at time of driving, and
the second information is information regarding the driver's driving tendency.

7. The system according to claim 2, wherein the terminal apparatus is configured to determine the first and second information, among the information acquired at the time of the driver's driving, in response to a predetermined operation by the driver.

8. The system according to claim 2, wherein the terminal apparatus is configured to determine the first and second information, among the information acquired at the time of the driver's driving, in response to the driver's reaction to the diagnostic result by the first diagnostic model.

9. The system according to claim 8, wherein the terminal apparatus is configured to acquire the reaction from a captured image or voice of the driver.

10. A method of operating a system comprising a terminal apparatus to be used by a driver of a vehicle and a server apparatus configured to communicate with the terminal apparatus, the terminal apparatus comprising a first diagnostic model configured to notify the driver of a diagnostic result according to the driver's driving at a first time, the server apparatus comprising a second diagnostic model configured to notify the driver of a diagnostic result according to the driver's driving at a second time longer than the first time, the method comprising holding, by the terminal apparatus, first information to be used for a diagnosis by the first diagnostic model, among information acquired at time of the driver's driving, and transmitting second information other than the first information to the server apparatus, to use the second information for a diagnosis by the second diagnostic model.

11. The method according to claim 10, wherein the terminal apparatus is configured not to transmit the first information to the server apparatus.

12. The method according to claim 10, wherein the terminal apparatus is configured to train the first diagnostic model using the first information.

13. The method according to claim 10, wherein the server apparatus is configured to train the second diagnostic model using the second information.

14. The method according to claim 10, wherein
the first information is information regarding the driver's driving operation or the driver's condition at time of driving, and
the second information is information regarding the driver's driving tendency.

15. The method according to claim 10, wherein the terminal apparatus is configured to determine the first and second information, among the information acquired at the time of the driver's driving, in response to a predetermined operation by the driver.

16. The method according to claim 10, wherein the terminal apparatus is configured to determine the first and second information, among the information acquired at the time of the driver's driving, in response to the driver's reaction to the diagnostic result by the first diagnostic model.
